(19) United States
(12) Patent Application Publication
(10) Pub. No.: US 2024/0249136 A1
(43) Pub. Date: Jul. 25, 2024

(54) METHOD OF SOLVING COMBINATORIAL OPTIMIZATION PROBLEMS USING MACHINE LEARNING MODELS ADAPTED FROM A DIFFERENT SET OF INPUT PROBLEMS, AND RELATED SYSTEM AND DEVICES

(71) Applicants: Amin BANITALEBI DEHKORDI, Vancouver (CA); Yong ZHANG, Richmond (CA)

(72) Inventors: Amin BANITALEBI DEHKORDI, Vancouver (CA); Yong ZHANG, Richmond (CA)

(21) Appl. No.: 18/156,823

(22) Filed: Jan. 19, 2023

(51) Int. Cl. G06N 3/08; G06F 17/11

(52) U.S. Cl. CPC G06N 3/08; G06F 17/11

(57) ABSTRACT

A method of solving combinatorial optimization problems using machine learning models adapted from a different set of input problems, and related system and devices. In a first stage training, the neural network is trained with a super-model for solving a first mixed integer linear program (MILP) instance using a source dataset. The neural network comprises one or more normalization layers, and receives a bipartite graph representation of an MILP sample of the MILP instance as input. In a second stage training, the super-model is adapted with a target dataset different from the source dataset in which only the normalization layers of the neural network are updated during the adapting.

### TECHNICAL FIELD

The present disclosure relates to neural networks, and more particularly to method of solving combinatorial optimization problems using machine learning models adapted from a different set of input problems, and related system and devices.

### BACKGROUND

A mixed integer linear program (MILP) is denoted by Equation (1):

$${arg min}_{x} \{ {c}^{T} x \vert Ax \leq b , l \leq x \leq u , x ∈ {ℤ}^{p} \times {n - p}^{} \} \qquad ( 1 )$$

where c∈ [symbol] ⁿ denotes the coefficients of the linear objective, A∈ [symbol] ^{m×n} and b∈ [symbol] ^{m} respectively denote the coefficients and upper bounds of linear constraints. There are m linear constraints and n variables where p≤n is the number of integer constrained variables. x, l and u are vectors in the [symbol] ⁿ space with l and u being the lower and upper bound vectors on the variable vector x.

A feasible solution is a solution that satisfies all the constraints in Equation (1) above. The optimal solution is a solution with the optional values for the variables in the vector x. A linear programing relaxation is when the last constraint in Equation (1) is relaxed and variable x∈ [symbol] ⁿ. This turns the MILP into a Linear Program (LP). The value of the objective value of the objective function c^{T}x in the LP solution is a lower bound to the original MILP. Any lower bound for the MILP is referred to as a dual bound. The LP solution can be a feasible solution if it satisfies the integral constraints, i.e., x∈ [symbol] ^{p}× [symbol] ^{n-p}. The primal bound is the objective value of a solution that is feasible, but not necessarily optimal. This could be an upper bound to the objective value of the MILP. An MILP instance is an optimization problem in the form of Equation (1).

Branch and bound algorithm: The branch and bound algorithm is a strong baseline for solving MILPs. It solves MILPs recursively by building a search tree at each node with partial assignment of integer values to the variables, and uses the information obtained at the node to converge to an optimal a near optimal solution. At each iteration, a leaf node is chosen to branch from (i.e., a variable to branch is chosen). The LP relaxation problem at this node is solved where the previously branched variables to be fixed at their integer value are constrained. Therefore, at each node p-r variables are relaxed where r≤p and a decision is made as to which of these variables are to be branched. The LP solution at this node provides a lower bound to the objective value of the original MILP solution as well as any further child nodes. If this lower bound is larger than the objective value of any known feasible solution, then the branch can be safely cut out of the search tree as it is guaranteed that the child nodes of this particular node will provide a larger (worse) objective value. If the LP relaxation at this node is not larger than the objective value of a known feasible solution, then the node may be expanded by selecting (branching on) a variable from the remaining (unfixed) variables at that node. Once a variable is selected, the tree is ramified into two branches and two child nodes are added to the search tree. The domain of the selected variable is divided into two non-overlapping intervals. The solution of the LP relaxation problem is chosen at the parent node for that particular variable as a reference. If xᵢ^{lp} is the LP relaxation solution of variable with index i at the parent node, the non-overlapping domains of child nodes will be xᵢ≥┌xᵢ^{lp}┐ and xᵢ≤└xᵢ^{lp}┘, where ┌·┐ and └·┘ are the ceiling and floor operators, respectively. A new MILP sample is generated from the MILP instance once branching on one variable is performed. The search tree is updated and the procedure is resumed until convergence. Linear programing is the backbone of the branch and bound algorithm. It is used for both finding the dual bounds at each node and to decide on the variable to branch with the assistance of some primal heuristics. Practically, the size of a search tree is in the exponential order with respect to the number of variables, therefore in some cases the search tree could be very large, and therefore time consuming to traverse.

The objective of combinatorial optimization is to find an optimal feasible solution within a discrete set of variables. In this context, the objective function is optimized under some constraints where a feasible solution satisfies the constraints and is at least partially integral. Combinatorial optimization in general tries to solve a retarget allocation problem subject to some retarget constraints. Most combinatorial optimization problems can be reduced to MILPs.

The applications of mixed integer programing are versatile. From solving scheduling problems in the transportation industry, renewable energy, telecommunication and aviation dispatching, to artificial intelligence and cloud retarget allocation for minimizing the GPU cluster energy consumption with some constraints on the performance, are all applications of integer programing. Solving such problems are computationally expensive and most of the mixed integer programs are classified as NP-hard. However, there exist algorithms that perform rather well in finding the optimal solution for such complicated problems at the expense of exponential solving time with respect to the problem size. Some optimization solvers such as SCIP, CPLEX, GUROBI and etc., have been developed in the form of optimization suites with internal heuristics to solve such problems.

However, such software suites often try to solve a mixed integer program under a complex multi-stage process. For example, using the branch and bound algorithm stages such as pre-solving, node selection, processing and branching are heavily coupled with each other. On the other hand, optimization solver suites have hundreds of adjustable parameters that need to be tuned for each problem. These limitations along with availability of a huge amount of data samples at ports, supply chains, and service providing cloud instances motivate the use of statistical properties of data via utilizing artificial intelligence.

It has been proposed to mimic the primal heuristics using methods by which a feasible but not necessarily optimal solution might be found. Elias Boutros Khalil, Pierre Le Bodic, Le Song, George Nemhauser and Bistra Dilkina in “Learning to branch in mixed integer programming”, Proceedings of the Thirtieth AAAI Conference on Artificial Intelligence, 2016, pg. 724-731, propose a branching scheme that predicts the success of running heuristics on a given node in the solutions space tree. Jian-Ya Ding, Chao Zhang, Lei Shen, Shengyin Li, Bing Wang, Yinghui Xu and Le Song in “Accelerating primal solution findings for mixed integer programs based on solution prediction”, Proceedings of the AAAI Conference on Artificial Intelligence, Vol. 34, No. 02, Apr. 3, 2020, pg. 1452-1459, propose to formulate an MILP instance as a tripartite graph base on which to train a Graph Neural Network (GNN) to predict solutions for binary variables. The basic concept behind most proposals to apply artificial intelligence to solve MILPs is imitation learning which is training a neural network that imitates full strong branching (FSB).

While the use of GNNs seems to be effective in learning computationally expensive FSB branching, such models are tailored to be used with high end GPU cards. As such, in the practical MILP solving environments in which only CPU cores are available they may not be useful. Prateek Gupta, Maxime Gasse, Elias B. Khalil, M. Pawan Kumar, Andrea Lodi and Yoshua Bengio in “Hybrid models for learning to branch”, Advances in neural information processing systems”, arXiv:2006.15212, Jun. 26, 2020, propose that a light weighted Multi-Layer Perceptron (MLP) brancher can be used in environments with no GPU availability. In a later approach, Shaked Brody, Uri Alon and Eran Yahav in “How attentive are graph attention networks?”, arXiv:2105.14491, May 30, 2021, propose to combine a learned primal heuristic and a branching policy in a solver simultaneously to tackle more realistic real-world problems. In particular, it is proposed to perform neural diving that learns primal heuristics and neural branching that learns a branching policy to achieve a better performance in terms of latency and accuracy.

The ML4CO (machine learning for combinatorial optimization) approaches can be categorized into two classes: (1) model centric in which an architecture is designed to imitate the target module, e.g., the variable selection module; and (2) data centric in which a fixed structure is used but the focus is on the data collection and model creation.

All the above methods assume there is a large enough training dataset available, and a neural network is trained to mimic a module within the solver. There remains a need for an improved approach for using machine learning and artificial intelligence to solve MILPs, particularly in cases in which the available dataset is not large enough to train a neural network for the imitation learning task.

### SUMMARY

The prior art approaches use a neural network that can solve MILP instances through imitation learning. In the neural network architecture, embedding layers are followed by two a back-to-back message passing (MPN) networks. Finally, branching is performed using a final MLP head. In general, using imitation learning seems to be a strong baseline when a solver's module is replaced with a neural network.

The prior art approaches assume that a large enough dataset is available to train a neural network for the imitation learning task. However, in many practical cases, the dataset is not large enough to train a neural network for the imitation learning task. For example, users may only have a limited set of MILP problems to provide. In such cases, it will be difficult to train a data-hungry neural network effectively. Moreover, in a cloud service provider's business model, it is often desired to include these kinds of methods inside the optimization solving services where a user can initiate the training process on their own custom data. As such, it is essential that the user model's creation be fast and easy-to-do. The existing solutions are technically complex and time-consuming.

The present disclosure provides a method of solving combinatorial optimization problems using machine learning models adapted from a different set of input problems, and related system and devices. The present disclosure also provides a method of solving MILPs using neural networks trained using statistical properties of MILP instances that imitate the branching (e.g., FSB branching) and primal heuristics used in highly complex state-of-the-art optimization solvers.

The present disclosure provides a method and related system and devices that build pre-trained super-models for ML4CO using available large datasets (such as free, public, or easy-to-collect MILP datasets) and allows users to easily personalize the pre-trained super-models based on their own data through a cloud-based application programming interface (API). The pre-trained super-models are built in two phases: (1) a pre-training phase in which an existing available dataset of MILPs (referred to as the “source dataset”) is used to build a highly capable neural network for the variable selection task; and (2) a fine-tuning/adaptation phase in which the pre-trained model is fine-tuned (or adapted) to a custom dataset (referred to as the “target dataset”). A method of adaptation is provided that is fast, easy-to-use, and allows the adoption of the pre-trained super-model for many various target datasets, such as cloud-based datasets.

Advantageously, the method of the present disclosure can be used to train neural networks to improve branching accuracy, reduce branching time, and increases convergence speed and accuracy when finding the optimal solution of an MILP. The method of the present disclosure comprises pre-training a super-model, thereby allowing artificial intelligence (AI)-based solutions to perform well in environments in which large amounts of data are not available. The method of the present disclosure also comprises adaptation/fine-tuning of the super-model, thereby allowing very fast model creation (customization) as the fine-tuning/adaptation step is lightweight. The method of the present disclosure provides a data-centric solution in that the method is architecture-agnostic, thereby allowing any kind of neural network architecture such as GCN, GAT and TGAT. The method of the present disclosure extends the concept of pre-training models from computer vision (CV) and natural language processing (NLP) applications to combinatorial optimization, thereby providing solutions to solve MILP problems in a large number of applications.

The methods of the present disclosure can be used to train neural networks to solve MILPs. The method of the present disclosure can be used to train neural networks to address a variety of problems and applications relating to, among other things, cellular networks, telecommunication networks, scheduling (e.g., in transportation industry), renewable energy, aviation dispatching, and artificial intelligence and/or cloud retarget allocation (for example, for minimizing the GPU cluster energy consumption with some constraints on the performance). With respect to cellular networks, the method of the present disclosure may be used to train neural networks to distribute available frequencies across antennas in a cellular network so as to connect mobile equipment and minimize interference between the antennas. This problem can be formulated as an integer linear program in which binary variables indicate whether a frequency is assigned to an antenna. With respect to telecommunication networks, the goal of these problems is to design a network of lines to install so that a predefined set of communication requirements are met and the total cost of the network is minimal. This requires optimizing both the topology of the network along with the setting the capacities of the various lines. In many cases, the capacities are constrained to be integer quantities. Usually there are, depending on the technology used, additional restrictions that can be modeled as linear inequalities with integer or binary variables. With respect to scheduling, these problems involve service and vehicle scheduling in transportation networks. For example, a problem may involve assigning buses or subways to individual routes so that a timetable can be met, and also to equip them with drivers. Here binary decision variables indicate whether a bus or subway is assigned to a route and whether a driver is assigned to a particular train or subway. With respect to AI in retarget allocation on cloud computing platforms, the methods of the present disclosure can be used with a cloud AI platform to access GPU clusters for training AI models on the cloud computing platforms. With cost efficient deep learning job allocation (CE-DLA), energy consumption of deep learning clusters can be minimized while maintaining the overall system performance within an acceptable threshold. The methods of the present disclosure can be used to train neural networks to optimally allocate the GPU clusters to the users while minimizing the energy consumption cost.

The present disclosure provides a method of solving combinatorial optimization problems using machine learning models adapted from a different set of input problems, and related system and devices. In a first stage training, the neural network is trained with a super-model for solving a first mixed integer linear program (MILP) instance using a source dataset. The neural network comprises one or more normalization layers, and receives a bipartite graph representation of an MILP sample of the MILP instance as input. In a second stage training, the super-model is adapted with a target dataset different from the source dataset in which only the normalization layers of the neural network are updated during the adapting.

In accordance with a first aspect of the present disclosure, there is provided a computer-implemented method for solving combinatorial optimization using a neural network, comprising: performing a first stage training of the neural network with a super-model for solving a first mixed integer linear program (MILP) instance using a source dataset, the neural network receiving a bipartite graph representation of an MILP sample of the MILP instance as input, the bipartite graph consisting of a group of variable nodes, a group of constraint nodes, and edges between nodes in the group of variable nodes and the group of constraint nodes, the neural network comprising one or more normalization layers, the source dataset comprising MILP samples for a second MILP instance different from the first MILP instance; and performing a second stage training of the neural network, the second stage training comprising adapting the super-model with a target dataset different from the source dataset, the target dataset comprising MILP samples for the first MILP instance, wherein only the normalization layers of the neural network are updated during the adapting.

In some or all examples of the first aspect, the first stage training comprises: (1-i) receiving an MILP sample of the first MILP instance; (1-ii) generating a representation vector based of the MILP sample of the first MILP instance; (1-iii) selecting one or more variables for the MILP sample from the representation vector; (1-iv) determining a classification from the one or more selected variables; (1-v) determining a loss based on the determined classification and a predetermined classification in the source dataset; (1-vi) updating one or more parameters of the neural network based on the determined loss; and (1-vii) repeating steps (1-i) to (1-vi) until the loss is below a threshold; wherein the adapting comprises: (2-i) receiving an MILP sample of the second MILP instance; (2-ii) generating a representation vector based of the MILP sample of the second MILP instance; (2-iii) selecting one or more variables for the MILP sample from the representation vector; (2-iv) determining a classification from the one or more selected variables; (2-v) determining a loss based on the determined classification and a predetermined classification in the target dataset; (2-vi) updating one or more normalization parameters of the one or more normalization layers of the neural network based on the determined loss; and (2-vii) repeating steps (i) to (vi) until the loss is below a threshold.

In some or all examples of the first aspect, the loss is determined in accordance with equation (1):

$$ℒ = - \sum y log \hat{y} \qquad ( 1 )$$

where the [symbol] is the loss, y is a ground truth classification of the respective source or target dataset, and ŷ is the determined classification of the neural network.

In some or all examples of the first aspect, the first stage training comprises: (1-i) receiving an MILP sample of the first MILP instance; (1-ii) generating a representation vector based of the MILP sample of the first MILP instance; (1-iii) selecting one or more variables for the MILP sample from the representation vector; (1-iv) determining a loss based on the one or more selected variables and one or more predetermined selected variables in the source dataset; (1-v) updating one or more parameters of the neural network based on the determined loss; and (1-vi) repeating steps (1-i) to (1-v) until the loss is below a threshold, and wherein the adapting comprises: (2-i) receiving an MILP sample of the second MILP instance; (2-ii) generating a representation vector based of the MILP sample of the second MILP instance; (2-iii) selecting one or more variables for the MILP sample from the representation vector; (2-iv) determining a loss based on the one or more selected variables and one or more predetermined selected variables in the target dataset; (2-v) updating one or more parameters of the neural network based on the determined loss; and (2-vii) repeating steps (i) to (vi) until the loss is below a threshold.

In some or all examples of the first aspect, the neural network comprises a graph convolutional neural network (GCN).

In some or all examples of the first aspect, the GCN performs a single graph convolution in the form of two interleaved half-convolutions, the graph convolution being performed by two successive convolution passes, one half-convolution from variable to constraints performed by a first convolution layer and the other half-convolution from constraints to variables performed by a second convolution layer, wherein the two successive convolution passes are accordance with equation (2):

$${c}_{i} ← {f}_{C} ( {c}_{i} , {\sum }_{j}^{( i , j ) ∈ ε} {g}_{C} ( {c}_{i} , {v}_{j} , {e}_{i , j} ) , ) , {v}_{j} ← {f}_{V} ( {v}_{j} , {\sum }_{i}^{( i , j ) ∈ ε} {g}_{V} ( {c}_{i} , {v}_{j} , {e}_{i , j} ) ) \qquad ( 2 )$$

for all i∈C,j∈V{1, . . . , n}, where f_{C}, f_{V}, g_{C} and g_{V} are 2-layer perceptrons with rectified linear activation unit (RELU) activation functions, wherein an affine transformation x←(x−β)/σ is applied immediately after each of the first and second convolution layers by respective first and second normalization layers which comprise the one or more normalization layers.

In some or all examples of the first aspect, the first and second convolution layers are unnormalized convolution layers.

In some or all examples of the first aspect, the one or more selected variables or classification determined based on the one or more selected variables are applied to a system for associated with cellular networks, telecommunication networks, scheduling, renewable energy, aviation dispatching, or artificial intelligence and/or cloud retarget allocation.

In some or all examples of the first aspect, the one or more selected variables or classification determined based on the one or more selected variables are applied to distribute available frequencies across antennas in a cellular network so as to connect mobile equipment and that interference between the antennas in the cellular network is minimized.

In some or all examples of the first aspect, the one or more selected variables or label or classification determined based on the one or more selected variables are applied to a determine network lines of a telecommunication network so that so that a predefined set of communication requirements are met and a total cost of the telecommunication network is minimized.

In some or all examples of the first aspect, the one or more selected variables or label or classification determined based on the one or more selected variables are applied to cost efficient deep learning job allocation (CE-DLA), wherein energy consumption of deep learning clusters is minimized while maintaining an overall system performance within an acceptable threshold.

In accordance with another aspect of the present disclosure, there is provided a computing device comprising one or more processors and a memory. The memory having tangibly stored thereon executable instructions for execution by the one or more processors. The executable instructions, in response to execution by the one or more processors, cause the computing device to perform the methods described above and herein.

In accordance with a further aspect of the present disclosure, there is provided a non-transitory machine-readable medium having tangibly stored thereon executable instructions for execution by one or more processors. The executable instructions, in response to execution by the one or more processors, cause the one or more processors to perform the methods described above and herein.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

FIG. 1 is a block diagram of an example simplified computing system that may be used in accordance with example embodiments of the present disclosure.

FIGS. 2A and 2B are bipartite graph representations of MILPs.

FIG. 3A is a schematic block diagram of a neural network for solving MILP instances in accordance with a first embodiment of the present disclosure.

FIG. 3B is a schematic block diagram of the neural network of FIG. 3A showing the graph convolutional neural network in more detail.

FIG. 4 is a flowchart of a method for pre-training a super-model to learn a variable selection task using a source dataset in accordance with an example embodiment of the present disclosure.

FIG. 5 is a flowchart of a method for adapting a super-model to learn a variable selection task using a target dataset in accordance with an example embodiment of the present disclosure.

FIG. 6 is schematic block diagram illustrating the adaption of the layers of a GCN of the neural network.

FIG. 7 is table showing experimental results using a dual integral reward metric for a load balancing dataset/benchmark.

FIG. 8 is table showing experimental results using a dual integral reward metric for a maritime inventory routing dataset/benchmark.

FIG. 9 is schematic block diagram of an AI-solver for solving MILPs in accordance with an embodiment of the present disclosure.

FIG. 10 is schematic block diagram of a system for training an AI-solver for solving MILPs in accordance with an embodiment of the present disclosure.

### DETAILED DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although such functions are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except wherein indicated otherwise either explicitly or inherently by context.

The following acronyms, abbreviations or initialisms are used in the present disclosure:

| | Acronym/Abbreviation/Initialism |
|---|---|
| AI | Artificial Intelligence |
| CO | Combinatorial Optimization |
| MILP | Mixed Integer Linear Programs |
| LP | Linear program |
| NN | Neural Network |
| GNN | Graph Neural Network |
| CNN | Convolutional Neural Network |
| (D)NN | (Deep) Neural Network |
| MLP | Multi-Layer Perception |
| B&B | Branch and Bound |
| FSB | Full Strong Branching |
| PSE | Pseudo-Cost |
| MPN | Message Passing Network |
| SaaS | Software as a Service |
| SCIP | Solving Constraint Integer Programs |
| GPU | Graphics Processing Unit |
| CPU | Central Processing Unit |
| NP | non-deterministic polynomial-time |
| DA | Domain Adaptation |
| ML4CO | Machine Learning for Combinatorial Optimization |
| GCN or GCNN | Graph Convolutional Neural Network |
| NLP | Natural Language Processing |

Within the present disclosure, the following definitions are used. The term “instance” means a single MILP. The term “sample” means a sample of an instance. Each instance is sampled to many iterations until the solver either solves the MILP instance or reaches a time limit in solving the instance. The term “LP relaxation” means when an integer constraint on variables is removed. The term “dual bound” means a lower bound to the MILP problem obtained by LP relaxation. The term “primal bound” means an objective value of a solution that is feasible but not necessarily optimal. The term “objective value” means the value of the objective function when evaluated at a certain point. The term “feasible solution” means a solution that satisfies all the constraints in an MILP but is not necessarily optimal. The term “transfer learning” means to fine-tuning a pre-trained NN with a custom dataset. The term “domain adaptation” means to update the weights of a trained NN so it performs well on a target dataset that is different than the source dataset it was initially trained on. The term “meta learning” means learning to learn a task as opposed to learning the task itself.

Within the present disclosure, the following sets of terms are used interchangeably: “combinatorial optimization problems” and “mixed integer programs”; and “pre-trained model” and “super-model”.

### Example Computing System

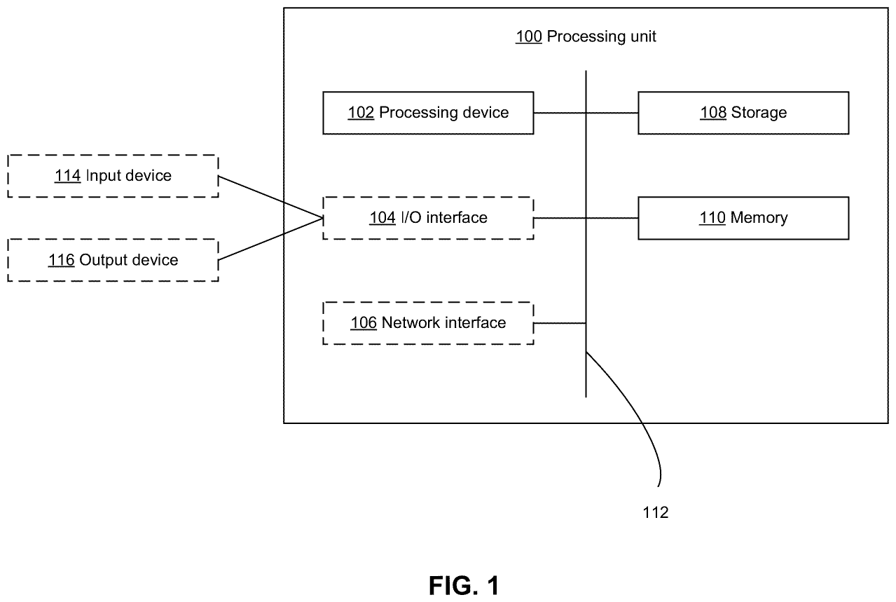

FIG. 1 illustrates a block diagram of an example simplified computing system 100, which may be a device that is used to solve mixed integer linear programs in accordance with examples disclosed herein. Other computing systems suitable for implementing embodiments described in the present disclosure may be used, which may include components different from those discussed below. In some examples, the computing system 100 may be implemented across more than one physical hardware unit, such as in a parallel computing, distributed computing, virtual server, or cloud computing configuration. Although FIG. 1 shows a single instance of each component, there may be multiple instances of each component in the computing system 100.

The computing system 100 may include one or more processing device(s) 102, such as a central processing unit (CPU) with a hardware accelerator, a graphics processing unit (GPU), a tensor processing unit (TPU), a neural processing unit (NPU), a microprocessor, an application-specific integrated circuit (ASIC), a field-programmable gate array (FPGA), a dedicated logic circuitry, a dedicated artificial intelligence processor unit, or combinations thereof.

The computing system 100 may also include one or more optional input/output (I/O) interfaces 104, which may enable interfacing with one or more optional input devices 114 and/or optional output devices 116. In the example shown, the input device(s) 114 (e.g., a keyboard, a mouse, a microphone, a touchscreen, and/or a keypad) and output device(s) 116 (e.g., a display, a speaker and/or a printer) are shown as optional and external to the computing system 100. In other examples, one or more of the input device(s) 114 and/or the output device(s) 116 may be included as a component of the computing system 100. In other examples, there may not be any input device(s) 114 and output device(s) 116, in which case the I/O interface(s) 104 may not be needed.

The computing system 100 may include one or more optional network interfaces 106 for wired or wireless communication with a network (e.g., an intranet, the Internet, a P2P network, a WAN and/or a LAN) or other node. The network interfaces 106 may include wired links (e.g., Ethernet cable) and/or wireless links (e.g., one or more antennas) for intra-network and/or inter-network communications.

The computing system 100 may also include one or more storage units 108, which may include a mass storage unit such as a solid state drive, a hard disk drive, a magnetic disk drive and/or an optical disk drive. The computing system 100 may include one or more memories 110, which may include a volatile or non-volatile memory (e.g., a flash memory, a random access memory (RAM), and/or a read-only memory (ROM)). The non-transitory memory(ies) 110 may store instructions for execution by the processing device(s) 102, such as to carry out examples described in the present disclosure. The memory(ies) 110 may include other software instructions, such as for implementing an operating system and other applications/functions. In some examples, memory 110 may include software instructions for execution by the processing device 102 to train a neural network and/or to implement a trained neural network, as disclosed herein.

In some other examples, one or more datasets and/or modules may be provided by an external memory (e.g., an external drive in wired or wireless communication with the computing system 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

There may be a bus 112 providing communication among components of the computing system 100, including the processing device(s) 102, optional I/O interface(s) 104, optional network interface(s) 106, storage unit(s) 108 and/or memory(ies) 110. The bus 112 may be any suitable bus architecture including, for example, a memory bus, a peripheral bus or a video bus.

### System Architecture

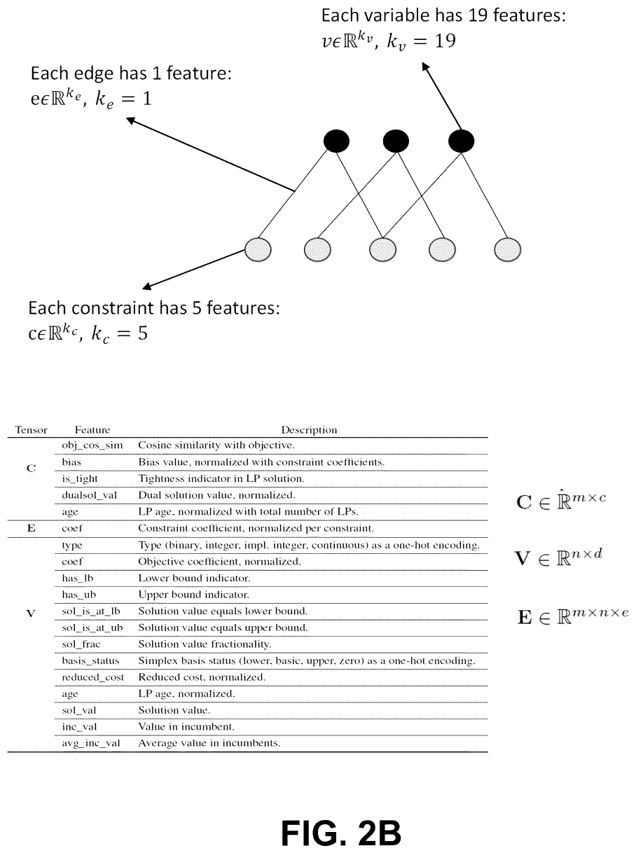

FIG. 3A is a schematic block diagram of a neural network 300 for solving MILP instances in accordance with a first embodiment the present disclosure. The neural network 300 may be referred to as a variable selection module. The neural network 300 comprises embedding layers 302, at least one a Graph Convolutional Neural Network (GCN) 310, one or more MLP (softmax) layer(s) 320, and optionally a classification (CLS) head (also known as a CLS layer) 330. The GCN 310 provides a base structure of the neural network 300 used for imitation learning of the B&B algorithm. In other embodiments, a neural network architecture other than a conventional GCN may be used for the base structure of the neural network. For example, the conventional GCN 310 can be substituted for any suitable neural network architecture such as a Graph Attention Network (GAT), temporo-attention graph neural network also known as a Temporo-Graph Attention Network (TGAT), other suitable Convolutional Neural Network (CNN), etc. Examples of a conventional GCN that may be used for the GCN 310 are described, for example, by M. Gasse, D. Chetelat, N. Ferroni, L. Charlin and A. Lodi, “Exact combinatorial optimization with graph convolutional neural networks”, Advances in Neural Information Processing Systems, 2019, 13 pages, and by A. Banitalebi-Dehkordi and Y. Zhang in “ML4CO: Is GCNN All You Need? Graph Convolutional Neural Networks Produce Strong Baselines For Combinatorial Optimization Problems, If Tuned and Trained Properly, on Appropriate Data”, Proceedings of the 2021 NeurIPS ML4CO competition, arXiv:2112.12251, Dec. 22, 2021, 13 pages. Examples of the GAT that may be used for the GCN 310 are described, for example, by Shaked Brody, Uri Alon and Eran Yahav in “How attentive are graph attention networks?”, arXiv: 2105.14491, May 30, 2021, 26 pages and by P. Velickovic, G. Cucurull, A. Casanova, A. Romero, P. Lio and Y. Bengio in “Graph attention networks”, arXiv: 1710.10903, Feb. 4, 2018, 12 pages. An example of a TGAT that may be used for the GCN 310 is described in U.S. patent application Ser. No. 17/747,778, entitled Method of Combinatorial Optimization Using Hybrid Temporo-Attentional Branching, And Related System And Devices, filed May 18, 2022, the content of which is incorporated herein by reference. In examples in which the GCN 310 is provided by a GAT, the GCN 310 may comprises a pair of GATs (also referred to as GAT modules).

The variable features, constraint features and edge features of the bipartite graph are each passed through an embedding layer 302 to encode the variable features, constraint features and edge features of the bipartite graph respectively. An embedding layer 302a encodes the variable features, an embedding layer 302b encodes the constraint features, and an embedding layer 302c encodes the edge features of the bipartite graph. A normalization module (not shown) may be provided prior to each embedding layer, for example, to normalize each feature value to be between 0 and 1 using a normalization technique known in the art. The embedding layers 302 generates a feature vector of the same size so the feature vectors can be mixed by the neural network 300 via the GCN 310. In some examples, the embedding layers 302 are a simple MLP with rectified linear activation unit (RELU) activation functions.

The MILP is modelled as a bipartite graph in which constraints and variables of the MILP are connected via edges and is received as input 301 into the neural network 300. The bipartite graph representation of the MILP may be provided as input or automatically generated. Each variable, constraint, or edge carries certain characteristics that are used to create features in the form of numerical vector/matrix values. These features are used in the GCN to create embeddings. Embeddings yield a softmax layer with a cross entropy loss to solve for a classification problem.

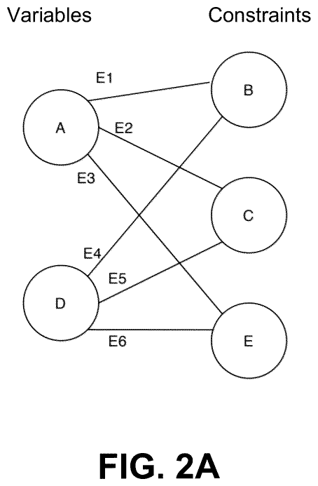

FIG. 2A is an illustration of a bipartite graph representation of a mixed integer linear program (MILP). The bipartite graph consists of two groups of nodes such that there are no edges between nodes within the same group. The only edges are between nodes in the two different groups. In FIG. 2A, nodes A and D form a first group denoted Variables and nodes B, C and E form a second group denoted Constraints. Edges E1, E2 and E3 are formed between node A in the Variables group and nodes B, C and D in the Constraints group. Conversely, edges E4, E5 and E6 are formed between node D in the Variables group and nodes B, C and E in the Constraints group. Each bipartite graph has n variables and m constraints, each of which are represented by a corresponding node. The variables, constraints and edges each have one or more features. The bipartite graph variable features, constraint features, and edge features may be automatically generated, for example, by solving software such as SCIP (Solving Constraint Integer Program), examples are known in the art. FIG. 2B is an illustration of a bipartite graph of an MILP and the features gathered for further processing. In the bipartite graph of FIG. 2B, each variable has 19 features, each constraint has 5 features, and each edge has 1 feature.

Sequential variable selections for the MILP represented by a bipartite graph that are made by the branch and bound (B&B) algorithm are modelled by a Markov decision process. The solver state at the t^{th} decision is denoted sₜ and contains information about the current dual bound, primal bound, the LP solution of each node, the currently focused leaf node, etc. During an episode the agent, based on the environment variables, and a variable selection policy π_{θ}(·), selects a variable at amongst all the fractional variables of the MILP, performs the branching-and-bounding as described above, and moves to the next state sₜ₊₁. Each state of the sₜ of the B&B Markov decision process at time slot t is modelled as a bipartite graph denoted by ( [symbol] , Cₜ, Vₜ, Eₜ) where is the [symbol] is the bipartite graph, Cₜ is the constraint features at time slot t, Vₜ is the variable features at time slot t, and Eₜ is the edge features at time slot t. A first set of n graph nodes represent variables x∈ [symbol] ⁿ and the other set of m nodes represent the constraints. Variable xⱼ in the MILP instance is represented by a node feature vector v_{j,t}∈ [symbol] ^{k}^{ᵥ} and the i^{th} constraint, on the other hand, is represented by a node feature vector c_{i,t}∈ [symbol] ^{k}^{ᵥ}. Node c_{i,t} is connected to the node v_{j,t} via the edge e_{ij,t}∈ [symbol] ^{k}^{ₑ} if and only if aᵢⱼ≠0. The vectors representing each node or edge are obtained by extracting features about the node or edge from the application environment. The application environment may comprise, for example, cellular networks, telecommunication networks, scheduling, renewable energy, aviation dispatching, or artificial intelligence and/or cloud retarget allocation. The features may be learned or optimized from data, or hand-crafted based on rules-based feature extraction methods developed through human experience. Example features include type of variables (binary, integer, etc.), dual solution value, objective coefficients, lower bound and upper bound indicators, reduced cost, etc. The feature vectors each have a size of a×b, where a is the size of the vector (a=64 in the shown example) and b is the number of features for variables, constraints and edges respectively (b=19, b=5, b=1 in the example of FIG. 2B).

The bipartite representation of the state is denoted by sₜ, where Cₜ∈ [symbol] ^{m×k}^{_{c}}, Vₜ∈ [symbol] ^{n×k}^{ᵥ} and Eₜ∈ [symbol] ^{m×n×k}^{ₑ}. To increase the capacity and to be able to change the node interactions, embedding layers are used to map each node and edge to space [symbol] ^{d}. For brevity and simplicity of notation, it is assumed that the embedding layers are already applied to ( [symbol] , Cₜ, Vₜ, Eₜ) and therefore, (c_{i,t}, v_{j,t}, e_{ij,t})∈ [symbol] ^{d×d×d}, ∀(c_{i,t}, v_{j,t}, e_{ij,t})∈ [symbol] .

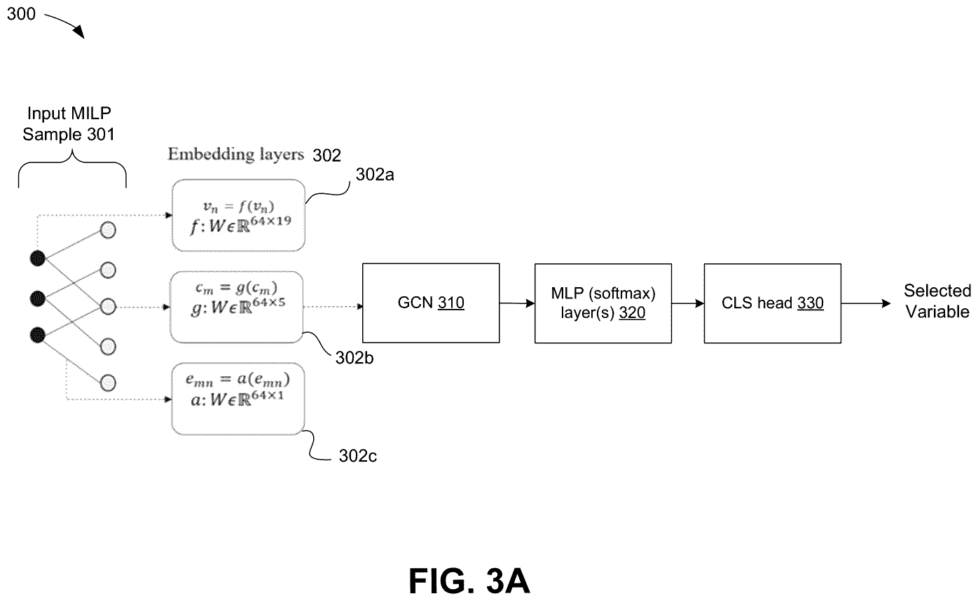

The first stage of the method of the present disclosure is to pre-train a super-model using a source dataset. The super-model can be general purpose, and be trained with large amounts of freely available data, with the aim of easily extending to down-stream tasks. Similar approaches have been introduced in computer vision by ImageNet pre-trained models, or in natural-language-processing by large language models such as GPT-3. In the first stage, the neural network is pre-trained first to learn about “variable selection” in general not “variable selection” specific to a particular dataset. The variable selection task is essentially a classification task. The pre-training is analogous to meta-learning: learning to learn the variable selection task by imitating variable selection. FIG. 4 is a flowchart of a method 400 for pre-training a super-model to learn a variable selection task using the source dataset (e.g., to learn to solve an MILP instance) in accordance with an example embodiment of the present disclosure. The method 400 is performed at least in part by the neural network 300. The method 400 may be performed by one or more processing devices 102 of the computing system 100 which have been configured to provide the neural network 300. The method 400 is a form of supervised learning.

At step 402, an MILP sample from a first dataset is received as input. The first dataset is the source dataset. The first dataset is a training data comprising a plurality of MILP samples for an MILP instance is received as input. An MILP instance is represented by a bipartite graph, wherein the bipartite graph consists of a group of variable nodes, a group of constraint nodes, and edges between nodes in the group of variable nodes and the group of constraint nodes. The first dataset is a large dataset. The first dataset may comprise hundreds, thousands or even tens of thousands of MILP samples or more. The first dataset may be a free, public, or easy-to-collect MILP dataset. Each MILP sample in the first dataset is associated with a predetermined set of one or more selected variables and optionally a classification for use in training the neural network 300. The objective of the method 400 is to train to the neural network 300 to make the same choices at each branching node for the same MILP sample and optionally to make the same classification for the same MILP sample.

At step 404, branching is performed for the MILP sample. The branching may be performed by an application solver which may be implemented in software, i.e. by a solver application separate from the neural network 300.

At step 406, features are extracted for variables, constraints, and edges of the MILP sample. The features are defined by feature vectors comprising a variable feature vector comprising variable features, a constraint feature vector comprising constraint features and an edge feature vector comprising edge features. The features may be extracted by the solver application. The variable features, constraint features and edge features may be extracted by the solver application using information about an application environment associated with the MILP instance. The application environment may comprise cellular networks, telecommunication networks, scheduling, renewable energy, aviation dispatching, or artificial intelligence and/or cloud retarget allocation. The results are stored as training data in the first dataset.

At step 408, the features are optionally normalized via a normalization module before the neural network 300. For example, the variable features, constraint features and edge features may be normalized so that each feature value is between 0 and 1 using, for example, a normalization technique known in the art. The normalization is performed to feed inputs to the neural network 300 to a known interval, 0 to 1 in the present embodiment. As described more fully below, the neural network 300 also includes normalization layers which are layers inside the neural network 300 that perform a normalization operation but to an interval that is learned from the training dataset. The learned interval can be any interval from a to b, depending on the training set.

At step 410, feature embeddings are generated for variables, constraints, and edges of the MILP sample. In this step, variable embeddings, constraint embeddings and edge embeddings are generated for the variable features, constraint features and edge features, respectively.

At step 412, the embeddings are passed to the GCN 310 of the neural network 300 which generates a representation vector of the MILP sample. Referring to FIG. 3B, the GCN 310 of the neural network 300 will be described in more detail. The GCN 310 comprises two graph convolution layers denoted convolution layer 1 (Conv-1) 312 and convolution layer 2 (Conv-2) 316. The GCN 310 models a variable selection policy π_{θ}(·) for the MILP instance and takes as input a bipartite state representation sₜ=( [symbol] , C, V, E) and performs a single graph convolution, in the form of two interleaved half-convolutions because of the bipartite structure of the input graph. The graph convolution is broken down into two successive convolution passes, one half-convolution from variable to constraints (V to C) being performed by convolution layer 1 (Conv-1) 312 and the other half-convolution from constraints to variables (C to V) being performed by convolution layer 2 (Conv-2) 316. In some examples, the two successive convolution passes may take a form in accordance with Equation (2):

$${c}_{i} ← {f}_{C} ( {c}_{i} , {\sum }_{j}^{( i , j ) ∈ ε} {g}_{C} ( {c}_{i} , {v}_{j} , {e}_{i , j} ) , ) , {v}_{j} ← {f}_{V} ( {v}_{j} , {\sum }_{i}^{( i , j ) ∈ ε} {g}_{V} ( {c}_{i} , {v}_{j} , {e}_{i , j} ) ) \qquad ( 2 )$$

for all i∈C,j∈V{1, . . . , n}, where f_{C}, f_{V}, g_{C} and g_{V} are 2-layer perceptrons with RELU activation functions. Following the two graph convolution layers 312 and 316, a bipartite graph with the same topology as the input but with potentially different node features, is obtained so that each node contains information from its neighbors.

Unlike conventional GCNs in which it is common to normalize each convolution operation by the number of neighbours, the graph convolution layers 312 and 316 perform unnormalized convolutions (convolutions performed on unnormalized input) to avoid a loss of expressiveness because the use of normalized convolutions (convolutions performed on normalized input) causes the learned model to become unable to perform a simple counting operation (e.g., in how many constraints does a variable appear). However, this introduces a weight initialization issue. Indeed, weight initialization in standard CNNs relies on the number of input units to normalize the initial weights, which in a GCN is unknown beforehand and depends on the dataset. To overcome this issue and stabilize the learning procedure, a simple affine transformation x←(x−β)/σ is applied immediately after each of the convolution layers 312 and 316 (i.e., after each of the summations in equation (2)) by respective normalization layers denoted normalization layer 1 (Norm-1) 314 and normalization layer 2 (Norm-2) 318. In other embodiments, more or fewer normalization layers may be provided. In other embodiments, the normalization layers may also be configured or located differently. The normalization parameters β and σ of the normalization layers 314 and 318 are initialized with an empirical mean and standard deviation of x on the training dataset, respectively. The normalization parameters β and σ are learned during training, i.e. over the course of the pre-training and fine-tuning. The use of unnormalized convolutions followed by normalization (for example, via the affine transformation) has been found to improve the generalization of performance on larger datasets.

At step 414, one or more variables for the MILP sample are selected from the representation vector generated by the GCN 310 in accordance with a variable selection policy of the GCN 310, wherein the one or more selected variables are to be applied to a system.

At step 416, a classification (also referred to as a label) is then optionally determined based on the one or more selected variables using the MLP softmax output layer(s) 320 of the neural network 300 by the CLS head 330.

At step 418, a loss is determined based on the one or more selected variables (or classification) and the predetermined set of one or more selected variables (or classification) for the MILP sample in the first dataset. In some examples, the loss is determined in accordance with the Equation (3):

$$ℒ = - \sum y log \hat{y} \qquad ( 3 )$$

where the [symbol] is the loss, y is the ground truth classification (or label), and ŷ is the predicted classification (or label) output by the MLP softmax output layer(s) 320 of the neural network 300. The loss [symbol] is a cross-entropy loss over predictions and ground truth labels. The ground truth labels are collected from the FSB branching rule which is very accurate but also very slow.

At step 420, one or more parameters (e.g., weights) of the neural network 300 are updated via a gradient decent algorithm based on the determined loss to reduce the loss (e.g., training error) through back propagation and train the neural network 300, i.e. one or more parameters (e.g., weights) of the GCN 310 are updated via a gradient decent algorithm based on the determined loss. The parameters of the neural network 300 may be updated to minimize a cross entropy loss.

At step 422, it is determined whether the loss is minimized (i.e., until the loss is below a threshold or validation accuracy is higher than a threshold). In response to a determination that the loss is not minimized (i.e., the loss is not below the threshold), processing returns to step 402 for a further iteration. In response to a determination that the loss is minimized (i.e., the loss is below the threshold), the method 400 ends.

The method may optionally further comprise outputting the one or more selected variables (step 430) and/or classification (step 440) to an external system for application thereon or applying the selected variables to the external system, such as a communication system or computing system. In some examples, the one or more selected variables associated are applied to a system associated with cellular networks, telecommunication networks, scheduling, renewable energy, aviation dispatching, or artificial intelligence and/or cloud retarget allocation. In some examples, the selected variables are applied to distribute available frequencies across antennas in a cellular network so as to connect mobile equipment and that interference between the antennas in the cellular network is minimized. In some examples, the selected variables are applied to a determine network lines of a telecommunication network so that so that a predefined set of communication requirements are met and a total cost of the telecommunication network is minimized. In some examples, wherein the selected variables are applied to cost efficient deep learning job allocation (CE-DLA), wherein energy consumption of deep learning clusters is minimized while maintaining an overall system performance within an acceptable threshold.

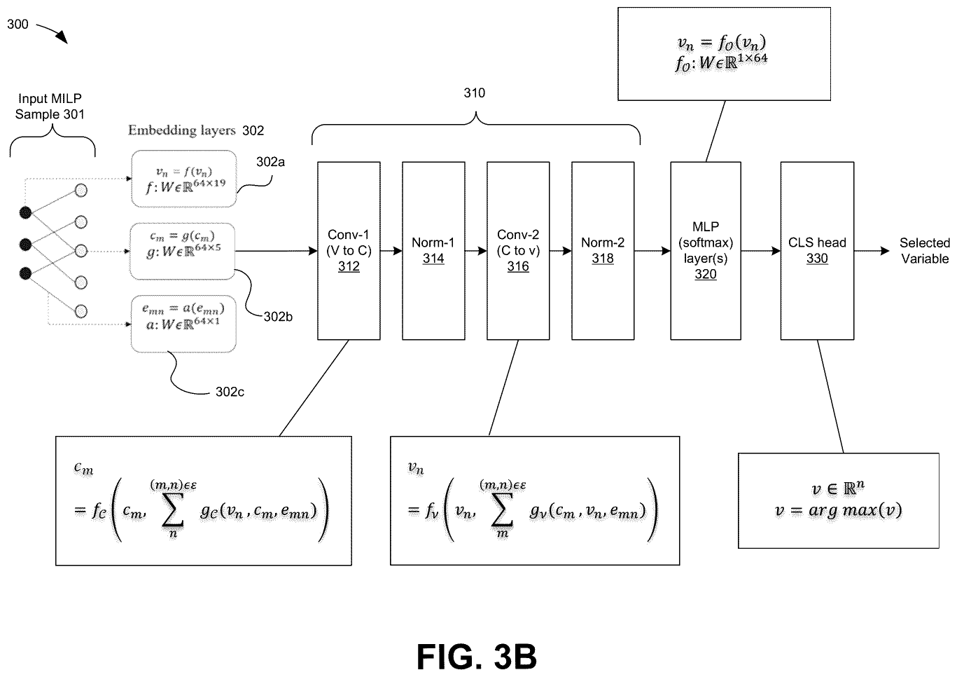

The second stage of the method of the present disclosure is to adapt (or fine-tune) a pre-trained super-model to learn a variable selection task using a target dataset provided by a client or user. In the second stage, the adaptation is performed by adapting only the normalization layer(s) of the GCN 310. This process is sometimes referred to in machine learning as domain adaptation. FIG. 5 is a flowchart of a method 500 for adapting a super-model to learn a variable selection task (e.g., to learn to solve an MILP instance) using the target dataset in accordance with an example embodiment of the present disclosure. The target dataset is a custom dataset comprising a number of MILP instances. The super-model learned by the neural network 300 does not need to be fully trained. with the target set data. Instead, the pre-training of the super-model to learn the variable selection is relied upon with adaptation of the normalization layer(s) to the target domain. If the target dataset is very small, fully fine-tuning will overfit and degrade the performance of the neural network 300.

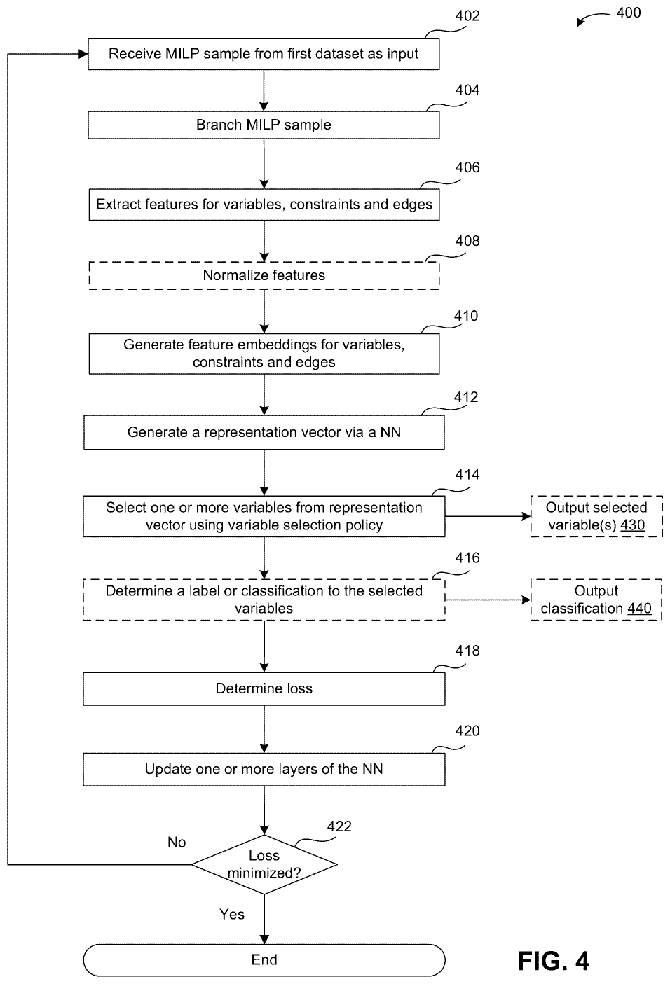

The method 500 is similar to the method 400 except that, in the first step 510, an MILP sample from a second dataset different from the first dataset is received as input, wherein the second dataset is the target dataset (also known as the custom dataset). The method 500 also differs from the method 400 in that in step 520, when updating one or more layers of the GCN 310, only the normalization layer(s) of the GCN 310 are updated while all of the other layers of the GCN 310 are frozen and not updated. FIG. 6 is schematic block diagram illustrating the adaption of the layers of the GCN 310 of the neural network 300 showing how the normalization layers of the neural network 300 are adapted while all of the other layers of the GCN 310 are frozen and not updated.

The steps (also referred to as operations) in the flowcharts and drawings described herein are for purposes of example only. There may be many variations to these steps/operations without departing from the teachings of the present disclosure. For instance, the steps may be performed in a differing order, or steps may be added, deleted, or modified, as appropriate.

### Experiments

Experiments to verify the effectiveness of the method and system of the present disclosure were performed. Two sets of experiments with the following settings were performed: a source dataset based on item-placement MILPs was used for pre-training comprises approximately 10,000 easy/small MILP instances; and a target dataset was used for adaptation and evaluation. In the first experiment, the target dataset was based on the load balancing dataset/benchmark with approximately 10,000 difficult/large MILP instances. In the second experiment, the target dataset was based on the maritime inventory balancing dataset/benchmark with approximately 100 difficult/large MILP instances. The GCN 310 architecture that was used was proposed by M. Gasse, D. Chetelat, N. Ferroni, L. Charlin and A. Lodi, “Exact combinatorial optimization with graph convolutional neural networks”, Advances in Neural Information Processing Systems, 2019, 13 pages. The experiments evaluated/compared the cases where the model was adapted versus the case of no adaptation or transfer-learning. The metric of evaluation was the dual integral reward introduced in the NeurIPS ML4CO challenge 2021 described, for example, by T. Zhang, A. Banitalebi-Dehkordi and Y. Zhang in “Deep reinforcement learning for exact combinatorial optimization: Learning to branch,” 26^{th} International Conference on Pattern Recognition, ICPR, 2022, which measures the area bounded by the solver's dual bound and the optimal solution. The performance evaluation experiments were performed using SCIP, a non-commercial public optimization suite.

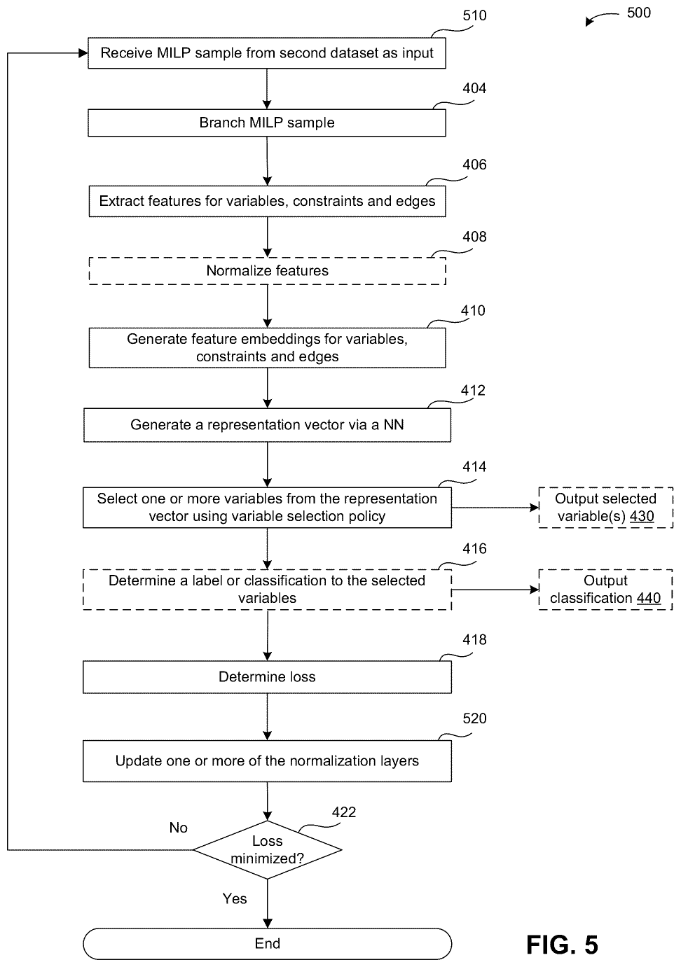

FIG. 7 is table showing experimental results of the first experiment using a dual integral reward metric for a load balancing dataset/benchmark. As noted above, the neural network was pre-trained on an item-placement dataset and partially adapted or fine-tuned using the load balancing dataset. The target dataset had approximately 10,000 MILP instances. As indicated by the results in the table of FIG. 7, transfer learning was performed effectively. Even at 50%, the performance is good as the target dataset is still relatively large.

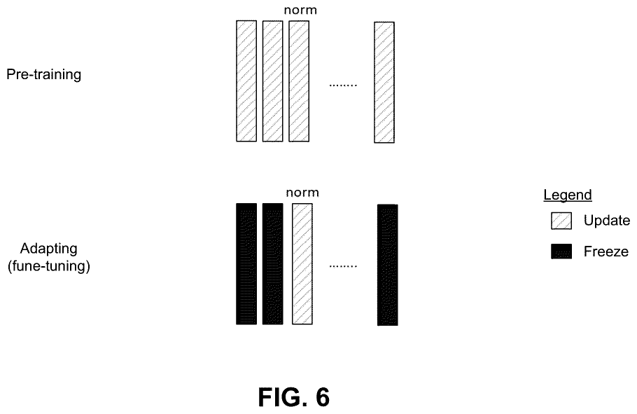

FIG. 8 is table showing experimental results of the second experiment using a dual integral reward metric for a maritime inventory routing dataset/benchmark. As noted above, the neural network was pre-trained on an item-placement dataset and partially adapted or fine-tuned using the maritime inventory dataset. The target dataset was approximately 10,000 MILP instances and the target dataset was small at approximately 100 MILP instances. As indicated by the results in the table of FIG. 8, transfer learning was performed effectively even though the target dataset is relatively small at 100 MILP instances, although the improvement is somewhat lower than the first experiment in which the target dataset is larger that in the second experiment.

### Applications

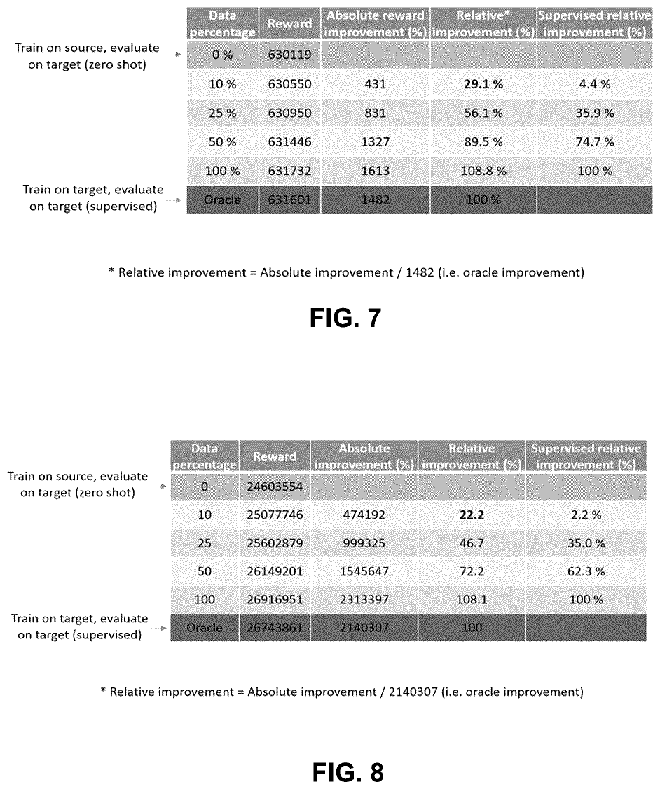

The method of the present disclosure can be integrated into an AI-solver. The method of the present disclosure can be provided as an AI-module where it can add to the capabilities of the AI-solver in cases where statistical properties of data are useable. The AI-module can be used in a large majority of cases where a dataset was previously available. FIG. 9 is schematic block diagram of a workflow of an AI-solver for solving MILPs in accordance with an embodiment of the present disclosure. To integrate into the solver, the method could be added as a drop-down option in training/inference services, for example as an AI assistant option for the solver. A user would be able to choose a neural network architecture to solve MILPs between the solver itself and different versions of AI-based techniques. The user would be able to choose a classification task for the MILP instances that the user wishes to solve as well as any parameters used for training. A training service in the form of Software as a Service (Saas) can be provided by a cloud service for training the AI-solver.

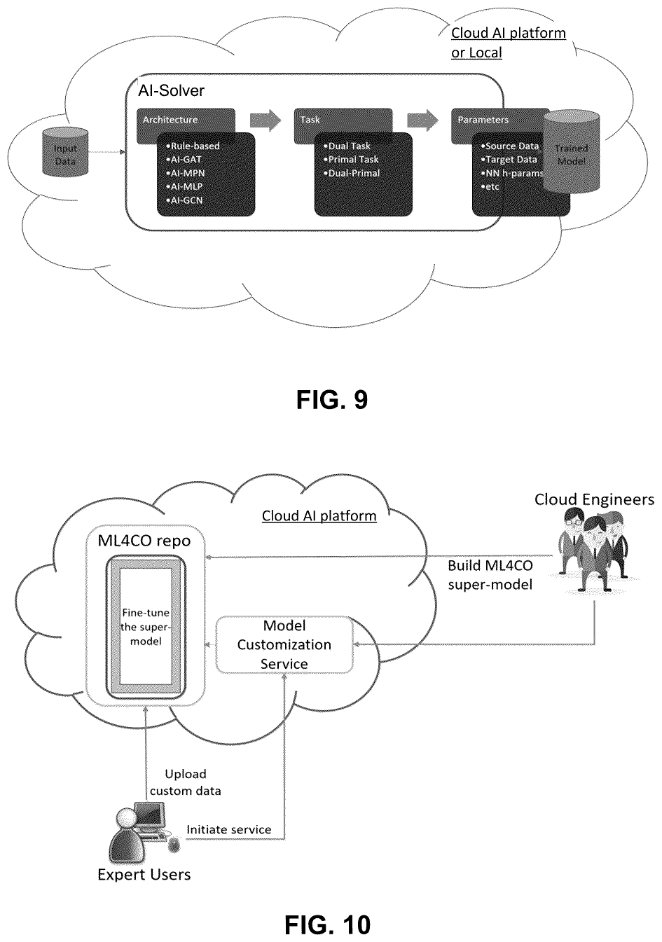

FIG. 10 is schematic block diagram of a system for training an AI-solver for solving MILPs in accordance with an embodiment of the present disclosure. As shown in FIG. 10, the AI-solver can be provided as part of a cloud AI platform for retarget allocation. Using the cloud AI platform, customers can access GPU clusters for training AI models on the cloud. With cost efficient deep learning job allocation (CE-DLA), the energy consumption of deep learning clusters can be minimized while maintaining the overall system performance within an acceptable threshold. The AI-solver can be used to optimally allocate the GPU clusters to the customers while minimizing the energy consumption cost.

Because the method of the present disclosure allows for a relatively fast and straightforward adaption/fine-tuning, users may be given the option of either using the pre-trained super-model directly or customizing the pre-trained super-model in real-time or substantially real-time based on proving a custom dataset as the target dataset. Therefore, it may be suitable to be included as an API within an online implementation of the AI-solver. Users can also create personalized models on top of the already capable pre-trained super-model in a relatively fast and straightforward way.

As noted above, the method of the present disclosure can be used to train a neural network to solve MILPs and can be used to address a variety of problems and applications relating to, among other things, cellular networks, telecommunication networks, scheduling (e.g., in transportation industry), renewable energy, aviation dispatching, and AI and/or cloud retarget allocation (for example, for minimizing the GPU cluster energy consumption with some constraints on the performance) by providing a trained neural network adapted or customized to the problem and application.

As noted above, with respect to cellular networks, the method of the present disclosure may be used to train neural networks to distribute available frequencies across antennas in a cellular network so as to connect mobile equipment and minimize interference between the antennas. This problem can be formulated as an integer linear program in which binary variables indicate whether a frequency is assigned to an antenna. In addition to retarget allocation on cloud platforms and frequency allocation in cellular networks, any other industrial applications of MILPs are also potential applications, e.g. airport flight scheduling, electric power grid, etc.

All publications and documents referred to in the present disclosure are incorporated herein by reference.

### General

Through the descriptions of the preceding embodiments, the present invention may be implemented by using hardware only, or by using software and a necessary universal hardware platform, or by a combination of hardware and software. The coding of software for carrying out the above-described methods described is within the scope of a person of ordinary skill in the art having regard to the present disclosure. Based on such understandings, the technical solution of the present invention may be embodied in the form of a software product. The software product may be stored in a non-volatile or non-transitory storage medium, which can be an optical storage medium, flash drive or hard disk. The software product includes a number of instructions that enable a computing device (personal computer, server, or network device) to execute the methods provided in the embodiments of the present disclosure.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present disclosure as a whole.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

Although the present invention and its advantages have been described in detail, it should be understood that various changes, substitutions and alterations can be made herein without departing from the invention as defined by the appended claims.

The present invention may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A computer-implemented method for training a neural network for solving combinatorial optimization problems, comprising:
performing a first stage training of the neural network with a super-model for solving a first mixed integer linear program (MILP) instance using a source dataset, the neural network receiving a bipartite graph representation of an MILP sample of the MILP instance as input, the bipartite graph consisting of a group of variable nodes, a group of constraint nodes, and edges between nodes in the group of variable nodes and the group of constraint nodes, the neural network comprising one or more normalization layers, the source dataset comprising MILP samples for a second MILP instance different from the first MILP instance; and
performing a second stage training of the neural network, the second stage training comprising adapting the super-model with a target dataset different from the source dataset, the target dataset comprising MILP samples for the first MILP instance, wherein only the normalization layers of the neural network are updated during the adapting.

2. The computer-implemented method of claim 1, wherein the first stage training comprises:
(1-i) receiving an MILP sample of the first MILP instance;
(1-ii) generating a representation vector based of the MILP sample of the first MILP instance;
(1-iii) selecting one or more variables for the MILP sample from the representation vector;
(1-iv) determining a classification from the one or more selected variables;
(1-v) determining a loss based on the determined classification and a predetermined classification in the source dataset;
(1-vi) updating one or more parameters of the neural network based on the determined loss; and
(1-vii) repeating steps (1-i) to (1-vi) until the loss is below a threshold;
wherein the adapting comprises:
(2-i) receiving an MILP sample of the second MILP instance;
(2-ii) generating a representation vector based of the MILP sample of the second MILP instance;
(2-iii) selecting one or more variables for the MILP sample from the representation vector;
(2-iv) determining a classification from the one or more selected variables;
(2-v) determining a loss based on the determined classification and a predetermined classification in the target dataset;
(2-vi) updating one or more normalization parameters of the one or more normalization layers of the neural network based on the determined loss; and
(2-vii) repeating steps (i) to (vi) until the loss is below a threshold.

3. The computer-implemented method of claim 2, wherein the loss is determined in accordance with equation (1):
$$ℒ = - \sum y log \hat{y} \qquad ( 1 )$$
where the [symbol] is the loss, y is a ground truth classification of the respective source or target dataset, and ŷ is the determined classification of the neural network.

4. The computer-implemented method of claim 1, wherein the first stage training comprises:
(1-i) receiving an MILP sample of the first MILP instance;
(1-ii) generating a representation vector based of the MILP sample of the first MILP instance;
(1-iii) selecting one or more variables for the MILP sample from the representation vector;
(1-iv) determining a loss based on the one or more selected variables and one or more predetermined selected variables in the source dataset;
(1-v) updating one or more parameters of the neural network based on the determined loss; and
(1-vi) repeating steps (1-i) to (1-v) until the loss is below a threshold;
wherein the adapting comprises:
(2-i) receiving an MILP sample of the second MILP instance;
(2-ii) generating a representation vector based of the MILP sample of the second MILP instance;
(2-iii) selecting one or more variables for the MILP sample from the representation vector;
(2-iv) determining a loss based on the one or more selected variables and one or more predetermined selected variables in the target dataset;
(2-v) updating one or more parameters of the neural network based on the determined loss; and
(2-vii) repeating steps (i) to (vi) until the loss is below a threshold.

5. The computer-implemented method of claim 1, wherein the neural network comprises a graph convolutional neural network (GCN).

6. The computer-implemented method of claim 5, wherein the GCN performs a single graph convolution in the form of two interleaved half-convolutions, the graph convolution being performed by two successive convolution passes, one half-convolution from variable to constraints performed by a first convolution layer and the other half-convolution from constraints to variables performed by a second convolution layer, wherein the two successive convolution passes are accordance with equation (2):
$${c}_{i} ← {f}_{C} ( {c}_{i} , {\sum }_{j}^{( i , j ) ∈ ε} {g}_{C} ( {c}_{i} , {v}_{j} , {e}_{i , j} ) , ) , {v}_{j} ← {f}_{V} ( {v}_{j} , {\sum }_{i}^{( i , j ) ∈ ε} {g}_{V} ( {c}_{i} , {v}_{j} , {e}_{i , j} ) ) \qquad ( 2 )$$
for all i∈C,j∈V{1, . . . , n}, where f_{C}, f_{V}, g_{C} and g_{V} are 2-layer perceptrons with rectified linear activation unit (RELU) activation functions, wherein an affine transformation x←(x−β)/σ is applied immediately after each of the first and second convolution layers by respective first and second normalization layers which comprise the one or more normalization layers.

7. The computer-implemented method of claim 6, wherein the first and second convolution layers are unnormalized convolution layers.

8. The computer-implemented method of claim 1, wherein the one or more selected variables or classification determined based on the one or more selected variables are applied to a system for associated with cellular networks, telecommunication networks, scheduling, renewable energy, aviation dispatching, or artificial intelligence and/or cloud retarget allocation.

9. The computer-implemented method of claim 1, wherein the one or more selected variables or classification determined based on the one or more selected variables are applied to distribute available frequencies across antennas in a cellular network so as to connect mobile equipment and that interference between the antennas in the cellular network is minimized.

10. The computer-implemented method of claim 1, wherein the one or more selected variables or label or classification determined based on the one or more selected variables are applied to a determine network lines of a telecommunication network so that so that a predefined set of communication requirements are met and a total cost of the telecommunication network is minimized.

11. The computer-implemented method of claim 1, wherein the one or more selected variables or label or classification determined based on the one or more selected variables are applied to cost efficient deep learning job allocation (CE-DLA), wherein energy consumption of deep learning clusters is minimized while maintaining an overall system performance within an acceptable threshold.

12. A computing device for solving combinatorial optimization, the computing device comprising:
one or more processors configured to:
perform a first stage training of a neural network with a super-model for solving a first mixed integer linear program (MILP) instance using a source dataset, the neural network receiving a bipartite graph representation of an MILP sample of the MILP instance as input, the bipartite graph consisting of a group of variable nodes, a group of constraint nodes, and edges between nodes in the group of variable nodes and the group of constraint nodes, the neural network comprising one or more normalization layers, the source dataset comprising MILP samples for a second MILP instance different from the first MILP instance; and
perform a second stage training of the neural network, the second stage training comprising adapting the super-model with a target dataset different from the source dataset, the target dataset comprising MILP samples for the first MILP instance, wherein only the normalization layers of the neural network are updated during the adapting.

13. The computing device of claim 12, wherein the one or more processors are configured to perform the first stage training by:
(1-i) receiving an MILP sample of the first MILP instance;
(1-ii) generating a representation vector based of the MILP sample of the first MILP instance;
(1-iii) selecting one or more variables for the MILP sample from the representation vector;
(1-iv) determining a classification from the one or more selected variables;
(1-v) determining a loss based on the determined classification and a predetermined classification in the source dataset;
(1-vi) updating one or more parameters of the neural network based on the determined loss; and
(1-vii) repeating steps (1-i) to (1-vi) until the loss is below a threshold;
wherein the adapting comprises:
(2-i) receiving an MILP sample of the second MILP instance;
(2-ii) generating a representation vector based of the MILP sample of the second MILP instance;
(2-iii) selecting one or more variables for the MILP sample from the representation vector;
(2-iv) determining a classification from the one or more selected variables;
(2-v) determining a loss based on the determined classification and a predetermined classification in the target dataset;
(2-vi) updating one or more normalization parameters of the one or more normalization layers of the neural network based on the determined loss; and
(2-vii) repeating steps (i) to (vi) until the loss is below a threshold.

14. The computing device of claim 13, wherein the loss is determined in accordance with equation (1):
$$ℒ = - \sum y log \hat{y} \qquad ( 1 )$$
where the [symbol] is the loss, y is a ground truth classification of the respective source or target dataset, and ŷ is the determined classification of the neural network.

15. The computing device of claim 12, wherein the one or more processors are configured to perform the first stage training by:
(1-i) receiving an MILP sample of the first MILP instance;
(1-ii) generating a representation vector based of the MILP sample of the first MILP instance;
(1-iii) selecting one or more variables for the MILP sample from the representation vector;
(1-iv) determining a loss based on the one or more selected variables and one or more predetermined selected variables in the source dataset;
(1-v) updating one or more parameters of the neural network based on the determined loss; and
(1-vi) repeating steps (1-i) to (1-v) until the loss is below a threshold;
wherein the adapting comprises:
(2-i) receiving an MILP sample of the second MILP instance;
(2-ii) generating a representation vector based of the MILP sample of the second MILP instance;
(2-iii) selecting one or more variables for the MILP sample from the representation vector;
(2-iv) determining a loss based on the one or more selected variables and one or more predetermined selected variables in the target dataset;
(2-v) updating one or more parameters of the neural network based on the determined loss; and
(2-vii) repeating steps (i) to (vi) until the loss is below a threshold.

16. The computing device of claim 12, wherein the neural network comprises a graph convolutional neural network (GCN).

17. The computing device of claim 16, wherein the GCN performs a single graph convolution in the form of two interleaved half-convolutions, the graph convolution being performed by two successive convolution passes, one half-convolution from variable to constraints performed by a first convolution layer and the other half-convolution from constraints to variables performed by a second convolution layer, wherein the two successive convolution passes are accordance with equation (2):
$${c}_{i} ← {f}_{C} ( {c}_{i} , {\sum }_{j}^{( i , j ) ∈ ε} {g}_{C} ( {c}_{i} , {v}_{j} , {e}_{i , j} ) , ) , {v}_{j} ← {f}_{V} ( {v}_{j} , {\sum }_{i}^{( i , j ) ∈ ε} {g}_{V} ( {c}_{i} , {v}_{j} , {e}_{i , j} ) ) \qquad ( 2 )$$
for all i∈C,j∈V{1, . . . , n}, where f_{C}, f_{V}, g_{C} and g_{V} are 2-layer perceptrons with rectified linear activation unit (RELU) activation functions, wherein an affine transformation x←(x−β)/σ is applied immediately after each of the first and second convolution layers by respective first and second normalization layers which comprise the one or more normalization layers.

18. The computing device of claim 17, wherein the first and second convolution layers are unnormalized convolution layers.

19. The computing device of claim 12, wherein the one or more selected variables or classification determined based on the one or more selected variables are applied to a system for associated with cellular networks, telecommunication networks, scheduling, renewable energy, aviation dispatching, or artificial intelligence and/or cloud retarget allocation,
wherein the one or more selected variables or classification determined based on the one or more selected variables are applied to distribute available frequencies across antennas in a cellular network so as to connect mobile equipment and that interference between the antennas in the cellular network is minimized,
wherein the one or more selected variables or label or classification determined based on the one or more selected variables are applied to a determine network lines of a telecommunication network so that so that a predefined set of communication requirements are met and a total cost of the telecommunication network is minimized, or
wherein the one or more selected variables or label or classification determined based on the one or more selected variables are applied to cost efficient deep learning job allocation (CE-DLA), wherein energy consumption of deep learning clusters is minimized while maintaining an overall system performance within an acceptable threshold.

20. A non-transitory machine-readable medium having tangibly stored thereon executable instructions for execution by one or more processors, wherein the executable instructions, in response to execution by the one or more processors, cause the one or more processors to:
perform a first stage training of a neural network with a super-model for solving a first mixed integer linear program (MILP) instance using a source dataset, the neural network receiving a bipartite graph representation of an MILP sample of the MILP instance as input, the bipartite graph consisting of a group of variable nodes, a group of constraint nodes, and edges between nodes in the group of variable nodes and the group of constraint nodes, the neural network comprising one or more normalization layers, the source dataset comprising MILP samples for a second MILP instance different from the first MILP instance; and
perform a second stage training of the neural network, the second stage training comprising adapting the super-model with a target dataset different from the source dataset, the target dataset comprising MILP samples for the first MILP instance, wherein only the normalization layers of the neural network are updated during the adapting.
